(19) United States
(12) Patent Application Publication
(10) Pub. No.: US 2016/0371062 A1
(43) Pub. Date: Dec. 22, 2016

(54) Method For The Automatic Presentation And Interaction Of A Data-Form User-Interface From Object-Model Metadata Under Media And Security Constraints

(71) Applicant: J. Wood Software Services LLC, Thiells, NY (US)

(72) Inventor: John M. Wood, Thiells, NY (US)

(21) Appl. No.: 14/741,987

(22) Filed: Jun. 17, 2015

(51) Int. Cl. G06F 9/44; G06F 17/30; G06F 17/24

(52) U.S. Cl. CPC G06F 8/35; G06F 17/243; G06F 17/30557; G06F 17/30377

(57) ABSTRACT

Systems and methods can be provided that are capable of the automatic and efficient design and implementation of a data-form user-interface with layout and interaction generated from object-model metadata under specific media and security constraints. An object-model typical of object oriented systems can be provided with additional metadata attributes attached to class members that will typically encode special commands used to guide the layout of a dynamically-generated form capable of displaying runtime data consistent with the aforementioned object-model, target media and any security permissions imposed on the user, along with interaction with that data by the user for the purpose of viewing, navigation and manipulation.

### BACKGROUND

Software application development consists of several phases, each of which often require widely different skill sets. Early on in application development, the object-model is designed based upon the requirements for storing the data collected by the application.

Because of their often-straightforward correlation with the real world and business processes, the information and process structure design standard of choice has become an object-model. Such a model consists of object class definitions, containing members (also known as fields). Members can depict either primitive data (for example, a string or number) or nested data (for example, a sub-object). Information used in business or other processes are analyzed and then described in this object oriented model, with “objects” becoming classes, and their properties becoming members of the class.

The object-model may be used to maintain a consistent structure to data, either stored in memory or in a storage device. Object-models can also allow for efficient access to data through programming languages, because of the conformity between the computer program requests and database structure.

The subsequent step is often to program the interface between the database system (typically an RDBMS) and the object-model. In this step, code is often written that will be able to store and retrieve data conforming to the object-model into native structures in a database system. In some cases, existing software products may be used to generate this database interface from an object-model.

The step after this is often to create the user interface that can allow the user to interact with that object-model. Whereas the first two steps can be implemented by a developer, or even a business analyst, the design of forms is often something that requires special design skills because of the requirements to be familiar with the different mediums that the application will be used through, accessibility concerns, consistency throughout the application, industry-standard conventions, the preferences of the specific user-base and experience in providing such interfaces.

In the present day, there are many different kinds of form-factors to consider when creating an application, including smart-phones, tablets, monitors and even large television-sized screens. Designing forms and navigation to accommodate each of these form-factors can be extremely time-consuming, and an ever-moving target as new technology emerges.

As such, there have been several programming libraries that facilitate handling such layouts that will automatically work across many form-factors, known as Responsive Layout libraries, and these focus on catering towards the presentation and composition of typographical content. For example, the popular Bootstrap library by Twitter allows for HTML mark-up that can be presented across many different form factors, however, the requirement is still there to write the programming that links the database interface, object-model and population and interaction with the Bootstrap forms.

Typically after the application is tested, deficiencies emerge in the object-model and changes are required. Implementing these changes involves revisiting the presentation and interaction programming required to interface the associated changed forms, and without the use of Responsive Layout libraries, not only each of the programming behind the forms, but each of the presentation scenarios, taking into account the different form-factors and accessibility requirements.

Special care is given to ensure the many different forms are consistent in presentation and interaction, an important consideration for ensuring usability with limited re-training which can dramatically impact the cost of deployment. While Responsive Layout libraries can help with this, much of the work in ensuring consistent interaction still remains a manual programming task that varies from one form to another. Attempts are made to share this code in re-usable libraries, but the variety of form layouts and the pressure to make use-case-optimized layouts often results in manual implementation of many forms.

In many enterprise applications, security is a central concern. Requirements to hide aspects of forms, or parts of forms such as specific fields, based on the user's permissions leads to the requirement of dynamically adjusting the layout to accommodate the space left by the fields that are hidden for security reasons. In complex forms this is very difficult to accomplish, and so either significant amount of code is written to dynamically adjust the form fields' locations, or the field is just displayed as an empty space compromising the form's design intentions.

The result is, typically, a lot of manual and often complex programming pervading the implementation of business applications.

### SUMMARY

The burden of maintaining the complex code associated with data form implementation reduces the motivation to enhance an application, which can seriously hamper an application's development turnaround and time-to-market, all significant concerns in the business world. Also, time and resource constraints may result in inconsistencies in how changes are applied in an application, and how security restrictions are implemented, resulting in the possibility of security vulnerabilities and additional training requirements, both of which can be very costly for businesses.

As new technology and user-interface conventions emerge, the large code-base associated with data forms in enterprise applications inhibit the ability to upgrade, potentially resulting in inconsistencies between older style forms and newer forms, itself leading to user-confusion and the necessity for additional training. The consequent reluctance to upgrade might result in a sub-par application that could lose place in the market as new applications emerge.

In light of these problems, some example embodiments include methods for the automatic and efficient design and implementation of a (potentially hierarchical) data-form layout and interaction from object-model metadata. By automatically creating forms from an object-model, the developer is often alleviated from the (often time-consuming) work of manually designing forms for each and every aspect of the application, allowing them instead to focus on business concerns.

In some embodiments, specific metadata attributes are added to an object-model to help guide a runtime form and navigation generator. The metadata is then used to create a user interface automatically from the object-model and information about the user (such as their security roles) and the media in which the form will be presented. The user-interface can be used to automatically display data conforming to the object-model in a visually-pleasing and usable manner, and can add necessary user-interface elements to manipulate said data if such a feature is allowed.

In some embodiments, the generator typically applies styling consistently during the layout process that can enable concerns such as pleasing design, security, consistency, time-to-create and accessibility to be addressed for all forms generated for the object-model.

### BRIEF DESCRIPTION OF THE DRAWINGS

FIG. 1A: A schematic diagram of an example computer network environment in which embodiments of the invention may be deployed.

FIG. 1B: A system architecture diagram representing an example embodiment in which the presentation and processor are running on the same computing device.

FIG. 2: An object-model representing the structure of an invoice according to an example embodiment.

FIG. 3: Layout-specific attributes added to members of a class in an object-model according to an example embodiment.

FIG. 4: Automatically generated form from the given object-model according to an example embodiment.

FIG. 5: Automatic addition of a link to add sub-records to the form according to an example embodiment.

FIG. 6: Showing a member with a Span attribute to have it span more than one cell according to an example embodiment.

FIG. 7: Showing a field group according to an example embodiment.

FIG. 8: Showing an initially-collapsed field group according to an example embodiment.

FIG. 9: Showing the omission of the “Client Name” field based upon the evaluation of a visibility condition according to an example embodiment.

FIG. 10: Showing a flowchart diagram representing the program flow of an embodiment of the enclosed invention according to an example embodiment.

### DESCRIPTION OF THE PREFERRED EMBODIMENTS

A description of example embodiments of the invention follows.

One example use according to an embodiment is to provide automatically generation of read-only and interactive forms from an object-model decorated with special metadata to help guide the generator under the constraints of specific media and security restrictions imposed on the user. This example embodiment is referred to as the Layout Application in the present disclosure.

### System Architecture

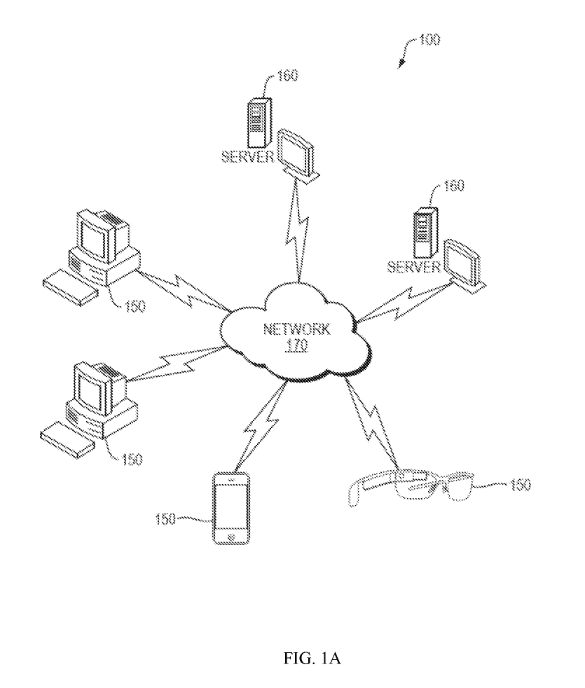

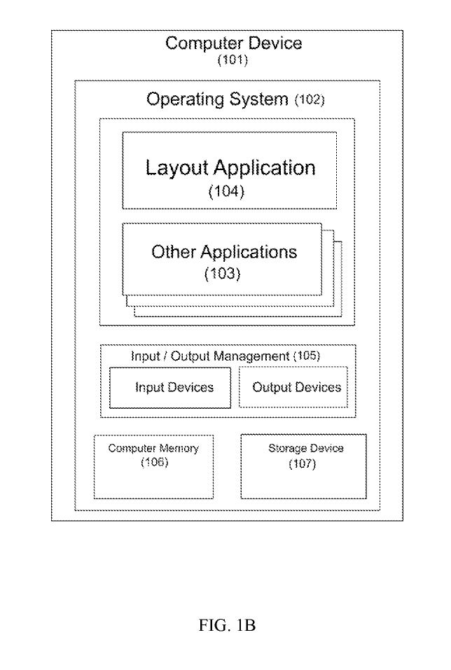

An example embodiment may be implemented in a system architecture similar to that shown in FIGS. 1A and 1B, in which an example Computer Device (e.g. 101, 150, 160) is running a computer operating system (102), that is hosting one or more computer applications (103), one of which would be the Layout Application (104). The operating system (102) would utilize input and output devices (105) for interaction with the applications, computer memory (RAM) (106) to temporarily store the Layout Application machine code for execution, and optionally a storage device (107) for storing information in a persistent storage.

In an alternative system architecture, the Layout Application (104) would be located on a separate machine, a server (160), and presentation information would be sent to a presentation application, such as a web browser, where it would be displayed to the user at a client computer/device. The server computer(s) may not be separate server computers but part of cloud network (170).

Client computers/devices ((e.g. 101, 150, 160) and server computers/devices (160) or a cloud network (170) provide processing, storage, and input/output devices executing application programs, such as the Layout Application (104). Client computers/devices 150 may be linked directly or through communications network (170) to other computing devices, including other client computers/devices (150) and server computer/devices (160). The communication network (170) can be part of a wireless or wired network, remote access network, a global network (i.e. Internet), a worldwide collection of computers, local area or wide area networks, and gateways, routers, and switches that currently use a variety of protocols (e.g. TCP/IP, Bluetooth®, RTM, etc.) to communicate with one another. The communication network (170) may also be a virtual private network (VPN) or an out-of-band network or both. The communication network (170) may take a variety of forms, including, but not limited to, a data network, voice network (e.g. land-line, mobile, etc.), audio network, video network, satellite network, radio network, and pager network. Other electronic device/computer networks architectures are also suitable.

Client processor/device (150) or server computers (160) in the processing environments of FIGS. 1A and 1B, which may be used to facilitate displaying audio, image, video or data signal information. Each computer (101), (150), (160) in FIGS. 1A and B contains a system bus, where a bus is a set of actual or virtual hardware lines used for data transfer among the components of a computer or processing system. The system bus is essentially a shared conduit that connects different elements of a computer system (e.g., processor, disk storage, memory, input/output ports, etc.) that enables the transfer of data between elements.

Attached to the system bus is an I/O device interface (105) for connecting various input and output devices (e.g., keyboard, mouse, touch screen interface, displays, printers, speakers, audio inputs and outputs, video inputs and outputs, microphone jacks, etc.) to the computer (101), (150), (160). Memory (106) provides volatile storage for computer software instructions (103), (104) used to implement software implementations of components of the automated presentation and interaction of a data-form user interface from object-model metadata (e.g. layout engine, presentation engine, object-modeler, request handler, etc.).

Software components (104), (103) of the example embodiments described herein may be configured using any programming language, including any high-level, object-oriented programming language.

The server (160) may include instances of the Layout Application (e.g. layout engine), which can be implemented as a client that communicates to the server (160) utilizing encrypted data packets (e.g. via SSL). In an example mobile implementation, a mobile agent implementation of the invention may be provided. A client server environment can be used to enable mobile security services using the server (160). It can use, for example, the XMPP protocol to tether a layout engine/application (104) on the device (101), (150) to a server (160). The server (160) can then issue commands to the mobile phone on request. The mobile user interface framework to access certain components of the system may be based on XHP, Javelin and WURFL. In another example mobile implementation for OS X and iOS operating systems and their respective APIs, Cocoa and Cocoa Touch may be used to implement the client side components (103), (104) using Objective-C or any other high-level programming language that adds Smalltalk-style messaging to the C programming language.

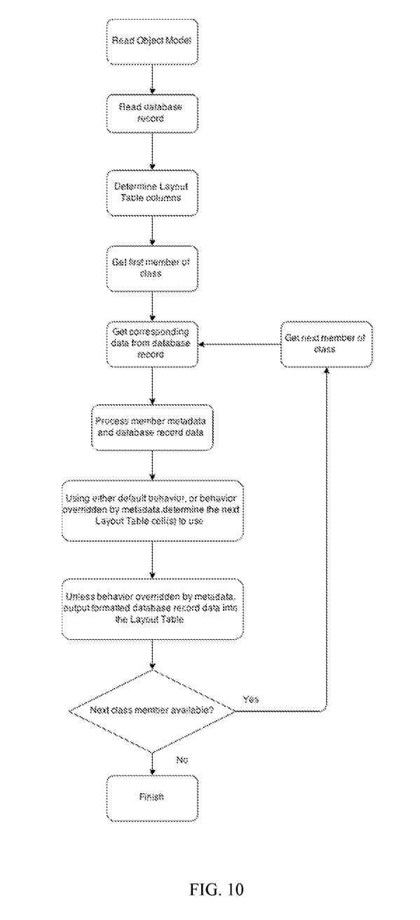

In one example embodiment, the Layout Application would be a computer program product that is executed on the CPU in the computer device (101), (150). A flowchart that describes an example overview of this process can be seen in FIG. 10. This process may run upon first display of the data form, and may run again as data is changed to reflect those changes dynamically on the display.

### Object-Model Examples

The Layout Application would be provided with data representing an object-model with additional metadata commands and parameters.

As described in FIG. 10, the metadata in the object-model can be used by the generator to determine how to lay out the form, and how the user can interact with the form, both to navigate the data in the form and potentially to manipulate or otherwise interact with that data.

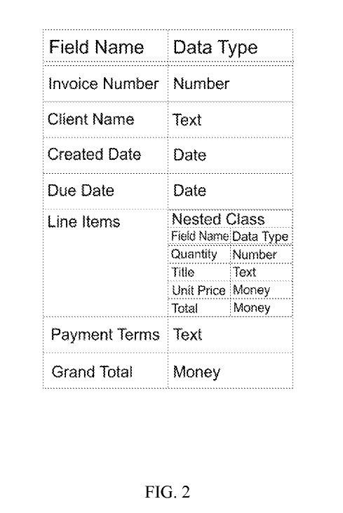

A typical object-model is adopted as a starting point. Such models are commonplace in application design as they are reflective of real-world information structures and processes. An example of such an object-model, representing an invoice, is shown in FIG. 2.

In this figure, an object-model is expressed as a table of members, each member consisting of a field name (also referred to as a label) and a data type (the type of data that field will hold). In the case where the data type is a nested class, the value of the field can be a complex object (or list of objects) with its own members. An example of a nested class in FIG. 2 is the Line Items of the invoice. This class, nested within the main class, has members for the fields you would see in the line item table in a typical invoice.

A number of additional metadata attributes are then added to the object-model, “decorating” the existing members. These metadata attributes signify to the form generator hints that guide it in laying out the fields for display and interaction. A single member can have zero, one or more attributes.

The metadata attributes available to be added will differ based on whether the member is a primitive type, or a nested class. A primitive type denotes a single value such as a number, date or text, or even a file attachment.

In some embodiments, members are nested classes.

The form generator will use a table structure to determine the layout of a particular class in the object-model, referred to as a “Layout Table”. The layout table will consist of a number of columns and rows, and often no header row or table lines will be visible.

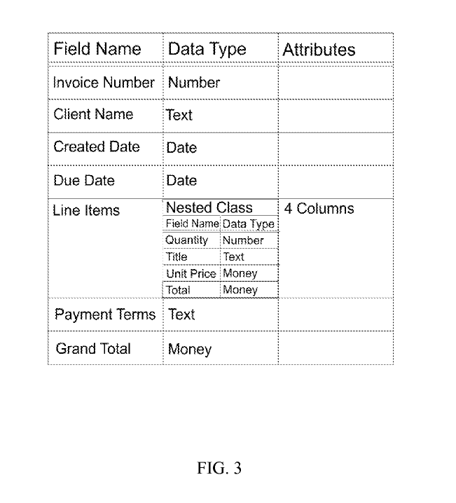

For a nested class member, an attribute can be added that will define the number of horizontal columns to use when laying out the form for that class. An example of such an attribute can be seen in FIG. 3, beside the member entry for Line Items. In this case the attribute specifies that the Line Items nested class will be rendered into a layout table with 4 columns.

The form generator will see this attribute and use that to determine how many columns to use when laying out the form. As a member is encountered, enumerated in the order defined in the object-model, it will be allocated to one cell in the table (unless instructed otherwise by attributes, as discussed below). This will continue until all cells are exhausted in that row, after which the allocations will continue on the next row at the cell in the first column. Each cell will typically display both the label and value. This will continue until all necessary visible members in the class have been displayed.

In certain situations, the system may decide to override the number of columns in the layout-table. If, for example, there are media (such as the display) constraints on the target display (eg. the computer screen or smart phone display) that mean using the default or specified number of columns would cause data to be off the screen and possibly require scrolling horizontally, the system may instead choose to override the number of columns to be fewer so that the user would not have to horizontally scroll.

### Examples of Generated Form Layout

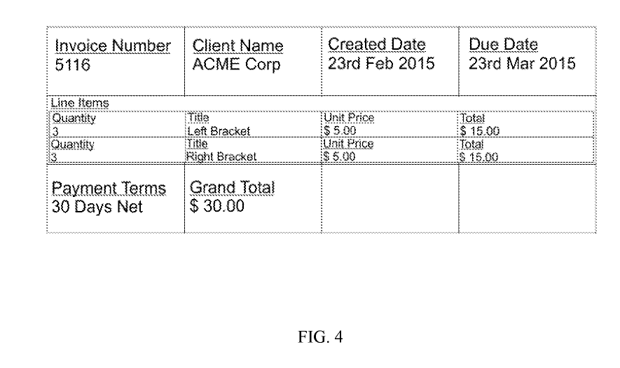

An example of the generated form layout related to the example in FIG. 3 can be seen in FIG. 4. The table lines have been retained in this figure so as to clearly demonstrate how the object-model members are placed in the layout table. In this example there are two Line Item objects nested within the Invoice object.

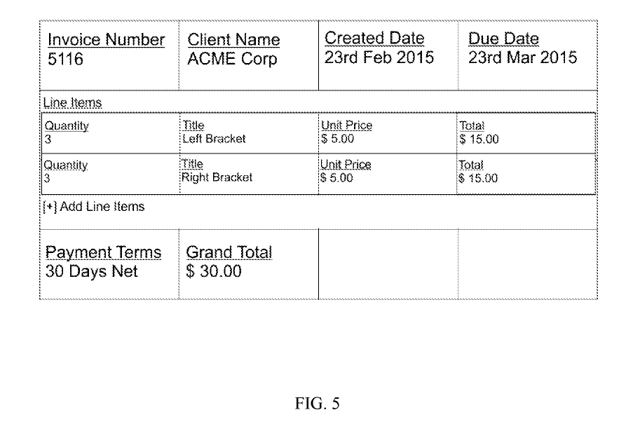

If a class contains a nested class member, it will normally be rendered to show the values as a new layout table nested within the row where the field is allocated. If the form is editable, it will be rendered to include a link (see the label “Add Line Items” in FIG. 4), and activating that link (through a mouse click or other mechanism) will make the a new generated sub-form for that class visible in-place, in which the user can enter the values of the new entry for that field. An example of this can be seen in FIG. 5.

Alternatively, the nested classes may not be incorporated into the main layout table, but instead shown in a separate area below the form. If the nested class corresponds to a list, that nested class may be displayed as a list. If the nested class corresponds to a single record, the nested class may be displayed in a layout table, consistent with the method of this embodiment. These nested classes may be displayed in a tabbed area below the form, in which one nested class will be displayed at a time as activated by the user, allowing for the efficient use of screen real-estate.

Another metadata attribute on a nested class member will indicate whether single or multiple instances of that sub-form can be added by the user to the parent form.

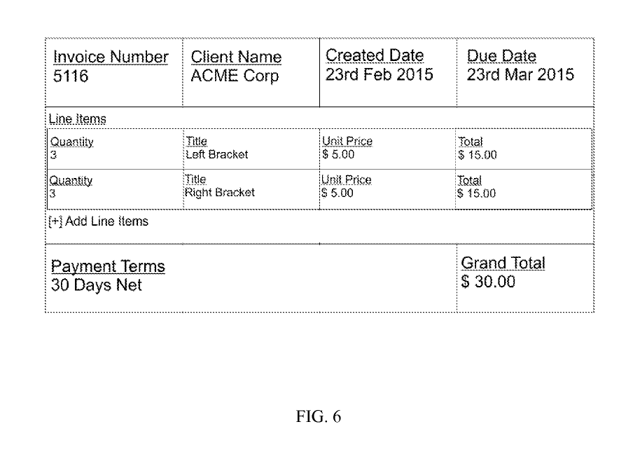

Primitive type fields may have more metadata attributes. Firstly an attribute will be available to control how many cells the member will take up in the layout table. In our example this attribute is known as the “Span”, and the definition and effect can be seen in FIG. 6, where the Payment Terms is annotated with the attribute Span 3, making the label and associated member value span over 3 cells, and in that example the subsequent member allocated to the fourth cell.

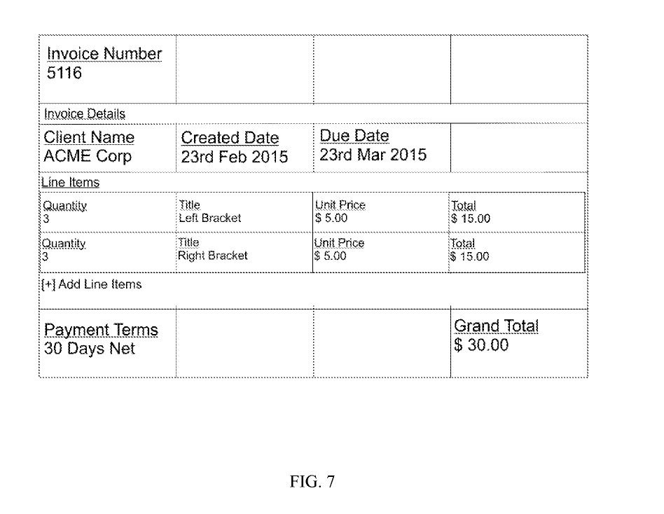

Yet another attribute will define the beginning of a new field group, called a “Field Group” attribute. The field group designates a series of related members displayed as a logical group in the form. A field group has a heading that is always displayed starting with the first column and spans the entire row, and all members related to that field group are displayed underneath the heading on the next row. An example of this is shown in FIG. 7, in which the Field Group attribute with the heading “Invoice Details” is added to the member “Client Name”, indicating the beginning of a new group. The group ends at the next member that defines a new field group, or at the end of the fields in that class.

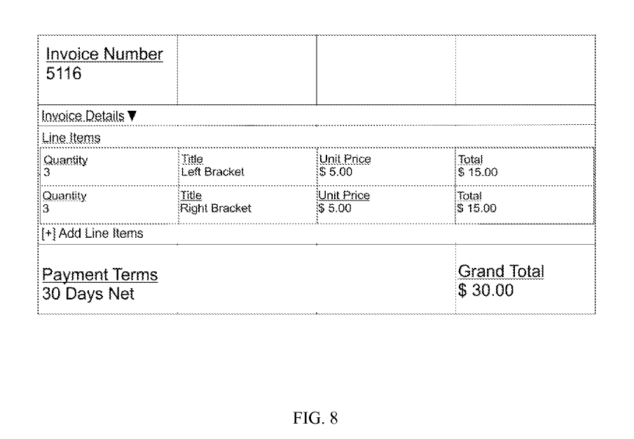

An additional attribute, referred to as “Collapsed Group”, can be added to a member that has a Field Group attribute, and indicates that all of the members related to that field group may be initially hidden until it is activated by the user through a toggle link, the toggle link bearing the title of the field group. An example of adding the “Collapsed Group” attribute to the member “Client Name” is shown in FIG. 8. Here it can be clearly seen that none of the fields are initially displayed in the group until it is clicked, after which it will display as shown in FIG. 7.

Another attribute will define whether the member should be visible to the user, and incorporated into the form layout, or hidden and used only for programming purposes or to store hidden information not accessible to the user. If a member is deemed to be excluded, then in populating the table layout that member will be skipped, and the cell it would ordinarily be allocated to will instead be allocated to the next visible member.

A variation on this attribute will define the visibility based on a condition expression, such as a condition that refers to the value of another field in that form or a parent form, or to the user being a member of a specific security user-role or user group. For example the user may be a department manager, and so they that user is made a member of the Department Managers group. The visibility of a field can be based upon the user being a member of that group, in which the field is displayed if they are in that group, and excluded if they are not.

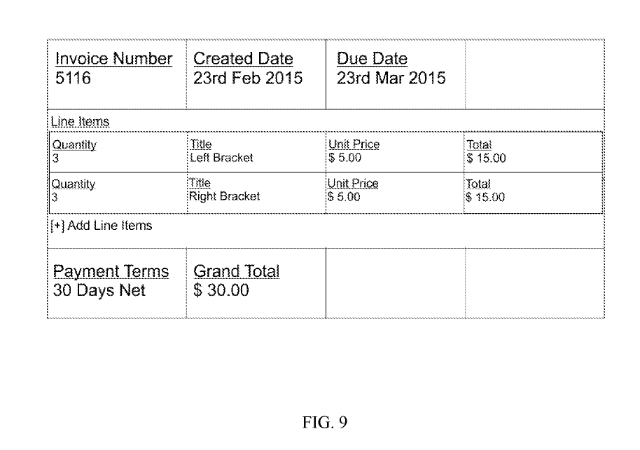

For example if, for confidentiality reasons, we wanted to hide the client name of the invoice unless the user was granted permission to access accounting data, we would add an attribute to the “Client Name” member such as “RequiresRole Accounting”. Users would then be given the user-role of “Accounting” if they were granted that permission. Then, when the form layout is generated, if the current user does now have the necessary user-role of “Accounting”, the Client Name field will be omitted, and the next field, Created Date, would be allocated to the cell previously reserved for that field. An example of the omitted “Client Name” can be seen in FIG. 9. Notice how, also, because “Client Name” starts a new field group but is now invisible, no new field group is started, and the subsequent members remain on the first row.

In certain embodiments, a different display is used for editable forms compared to read-only forms. Another attribute will define whether the field is editable by the user. An editable field will be displayed in an editable form, where as a non-editable field will only be incorporated into the viewing of the form, but excluded from the editable form.

Lastly, a metadata attribute will define whether a primitive member should be displayed in a summary view of records of that particular class type, or only when viewing the detail of a particular record. A summary view will display fewer fields of that record, and will be useful for displaying a list of records on the same screen, for example in a table. The detail view will display more fields, and will be more suitable to setting focus to a particular record to view more information not present in the summary view.

### Further Example Features

Thus, it should now be evident that certain example embodiments can provide the user of the embodiment with the capability to focus on defining an object-model while having the form layout and interaction generated automatically, in a manner suitable to particular display devices, honoring the particular security restrictions of the user. This potentially allows for a consistent interface across the system that can be simple to maintain and provide considerable time-saving value during the development and maintenance process, and potentially allowing security control to easily be implemented without having to redesign the form layout.

Detailed illustrations of a mechanism for generating a form layout and interaction system from an object-model in accordance with the present invention have been provided above for the edification of those of ordinary skill in the art, and not as a limitation on the scope of the present invention. Numerous variations and modifications within the spirit of the present invention will of course occur to those of ordinary skill in the art in view of the embodiments that have now been disclosed. For example, while in the described embodiment, the present invention can be implemented for a GUI for general purpose computers, the present invention may also be effectively implemented for any machine or device capable of the display of graphics, such as a mobile phone. The scope of the present inventions should, therefore, be determined not with reference to the above description, but should instead be determined with reference to the appended claims, along with the full scope of equivalents to which such claims are entitled.

One such variation in the implementation of the present invention may involve the implementation of the system in an HTML website, in which the object-model and form generation occurs on the server and is rendered to HTML that is delivered to the client.

Another variation may involve the displaying of nested-forms in a more efficient manner such as a table, where instead of showing generated forms for each sub-form, it would show a row in a table.

Another variation may involve changing how the field labels and data values are displayed. In one variation the label may display with the data, occupying the same cell, in another variation the label may take one cell and the value take the next cell.

Another variation may involve providing an attribute that can override the label to use for that member.

The manner in which the object-model is defined may vary greatly, in some cases the object-model being defined in text files, and in other times being defined through a graphical user interface.

The teachings of all patents, published applications and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

1. A computer-implemented method of operating a computing device, the method comprising:
configuring an object-model with class definitions, such that a class in the object-model includes respective class members having fields of at least one of: simple values or nested classes;
providing attributes to the classes and the respective class members based on the object-model by configuring specific commands and associated parameters to control presentation of associated data values on a computer display;
providing a database interface to retrieve, add, or update data conforming to the object-model; and
causing the object-model, the database interface, and the provided attributes to generate a form field to display, or enable input of, the conformed data, such that generation of the form field utilizes a layout table display configuration, which is populated row by row, from left to right, with member labels and values from the conformed data, in the order in which the class members are defined in the object-model.

2. The computer-implemented method of claim 1 wherein the number of columns in the layout table are configurable.

3. The computer-implemented method of claim 1 wherein said provided attributes control whether data from the respective class member is included or excluded from the form population.

4. The computer-implemented method of claim 1 wherein the provided attributes control the number of layout table cells, including fractions of cells, for the associated class member's cell to occupy.

5. The computer-implemented method of claim 1 wherein the provided attributes control whether the class member is included in an editable form or only included in a non-editable form.

6. The computer-implemented method of claim 1 wherein the provided attributes control whether the class member is displayed at the first cell of the next row in the layout table, and that population of subsequent class members continue from that point in the layout table.

7. The computer-implemented method of claim 6 wherein the provided attribute includes text that is displayed above the class member label to suggest the start of a grouping of subsequent class members, comprising either the remaining class members in the same class, or all class members up to the next grouping.

8. The computer-implemented method of claim 7 wherein the provided attribute includes an option that controls whether the aforementioned grouping is initially collapsed, such that all class members within said grouping are not incorporated into the layout, and take up no room in the layout table, but the group title is displayed and activated by the user to toggle the including of the class members in that group in the layout.

9. The computer-implemented method of claim 3 wherein the provided attribute includes a logical expression that, when evaluated upon form-initialization or when other class member values are changed, determines whether the class member will be visible.

10. The computer-implemented method of claim 3 wherein the provided attribute includes one or more user-role names that determine whether the class member will be visible based upon the presence of the assignment of said user-roles to the current user of the form.

11. The computer-implemented method of claim 1 wherein members of nested classes are incorporated into the layout table on the next row, occupying all cells in that row, rendered as a new layout table embedded within that row presented in a manner consistent with the method of the embodiment herein.

12. The computer-implemented method of claim 11 wherein said nested class members are configured to be excluded from the form layout initially and only included upon activation of a link incorporated into the form, dependent upon a specific attribute of said class member.

13. The computer-implemented method of claim 1 wherein said form may be displayed in summary view, in which fewer class members are displayed, or detail view, in which more class members are displayed.

14. The computer-implemented method of claim 13 in which the class members to exclude from the summary view are controlled through specific attributes added to each of said class members.

15. The computer-implemented method of claim 2 wherein either the default or configured number of table-layout columns may be automatically overridden if a display constraint is detected in which showing fewer columns would make the layout more readily fit on the target display.

16. The computer-implemented method of claim 1 wherein members of nested classes are excluded from the layout table, instead each showing as complete or partial lists in a separate tabbed-display either shown adjacent to the form, or hidden entirely if indicated by an attribute.

17. A computer program product stored on a non-transitory computer readable medium executing on at least one computing device, the computer program product having computer readable instructions, which when executed cause the computer device to:
store an object-model in computer memory, the object-model including class definitions, such that a class in the object-model has respective class members including fields of simple values or nested classes;
provide attributes to the classes and the respective class members based on the object-model by configuring specific commands and associated parameters to control presentation of associated data values on a computer display;
provide a database interface to retrieve, add, or update data conforming to the object-model; and
cause the object-model, the database interface, and the provided attributes to generate a form field to display, or enable input of, the conformed data, such that generation of the form field utilizes a layout table display configuration, which is populated row by row, from left to right, with member labels and values from the conformed data, in the order in which the class members are defined in the object-model.

18. A computer system comprising:
a database having an electronic interface configured to retrieve, add, or update data conforming to a secure object-model;
the secure object-model configured with class definitions, such that a class in the object-model includes respective class members having fields of at least one of: simple values or nested classes;
the secure object-model configured to provide attributes to the classes and the respective class members based on the object-model by configuring specific commands and associated parameters to control presentation of associated data values on a computer display;
the secure object-model configured to cause the database electronic interface to retrieve, add, or update data conforming to the object-model; and
the secure object-model configured to direct the database interface and the provided attributes to generate a form field to display, or enable input of, the conformed data, such that generation of the form field utilizes a layout table display configuration, which is populated row by row, from left to right, with member labels and values from the conformed data, in the order in which the class members are defined by the secure object-model.
